(19) United States
(12) Patent Application Publication
(10) Pub. No.: US 2025/0212042 A1
(43) Pub. Date: Jun. 26, 2025

(54) SIGNAL TRANSMITTING APPARATUS, NETWORK NODE, AND METHODS FOR MEASURING AND GENERATING CHANNEL STATE INFORMATION REPORT

(71) Applicant: Huawei Technologies Co., Ltd., Shenzhen (CN)

(72) Inventors: Salah Eddine Hajri, Munich (DE); Thorsten Schier, Munich (DE)

(21) Appl. No.: 19/079,877

(22) Filed: Mar. 14, 2025

Related U.S. Application Data
(63) Continuation of application No. PCT/EP2022/075634, filed on Sep. 15, 2022.

(51) Int. Cl. H04W 24/10; H04B 7/06; H04B 17/318

(52) U.S. Cl. CPC H04W 24/10; H04B 7/0626; H04B 7/06952; H04B 17/318

(57) ABSTRACT

A signal transmitting apparatus configured for generating a statistical channel state information (CSI) report for beam reporting is configured to select a subset of configured reference signal (RS) resources and perform measurements of qualities on the subset of RS resources. Further, the signal transmitting apparatus is configured to determine signal quality for each measured RS resource and determine statistics for the determined signal qualities. The signal transmitting apparatus predicts a future signal quality based on the statistics for the determined signal qualities and generates the statistical CSI report based on the statistics for the determined signal qualities. Further, the signal transmitting apparatus transmits the statistical CSI report to a network node and receives an indication of one or more beams in response thereto. The indicated beams are selected based, at least, on the statistical CSI report with dynamic beam reporting format for guided beam prediction and for beam management.

### CROSS-REFERENCE TO RELATED APPLICATIONS

This application is a continuation of International Application No. PCT/EP2022/075634, filed on Sep. 15, 2022, the disclosure of which is hereby incorporated by reference in its entirety.

### TECHNICAL FIELD

The present disclosure relates generally to the field of wireless communication systems and more specifically, to a signal transmitting apparatus and a method for generating a channel state information (CSI) report. Furthermore, the present disclosure relates specifically to a network node and a method for managing CSI measurements and reporting.

### BACKGROUND

Each generation of radio access networks is characterized by a leap in performance, usually enabled by multiple technical innovations. This applies to the fifth generation (5G) new radio (NR) access network technology that will incorporate extensive use of machine learning at different levels. In general, supporting machine learning operations at the radio access network encompass enhancements for data collection, machine learning life cycle management, required signalling and protocol update, among others. Nevertheless, to achieve the full potential of machine learning methods in radio access networks, standard support is needed with adapted signalling framework

Enhancing a radio access network in order to enable an efficient support of machine learning operations, at the network lower layers (e.g., Layer 1, Layer 2, Layer 3), is not straightforward as the requirements for optimized machine learning operations are not forcibly aligned with the requirements of other new radio interface features. As a result, careful design of the coordination between different components or functions is needed, taking into consideration, among others, hardware constraints, relevant to the capabilities of a client device and/or a network node, propagation conditions, different mobility scenarios, traffic type key performance indicators. Another critical design aspect resides in the supported levels of collaboration between different network nodes and different client devices, in machine learning operations, such as data collection and preparation, model construction, training and deployment, model life cycle management.

In certain scenarios, using beamforming with multiple antennas, for signals transmissions and receptions, is critical, especially if the radio access network is operating in high frequency ranges. Consequently, beam management procedures are rendered critical. Practically, beam management targets the selection of the best transmission and reception beams, i.e. beamforming weights, for each transmitted signal and include, beam selection at the network node side, beam selection at the client device side, beam monitoring and failure recovery. Beam management methods need to achieve an optimized accuracy, overhead, computational load and latency trade-off. On one hand, narrow beams enables to increase coverage area but require increased measurement and reporting loads. On the other hand, wide beams enable to reduce the needed measurements but suffer from shorter reach, which penalizes client devices at cell edge. Additionally, considering the mobility of the client device, the optimal beams may vary over time, which further increase the need for radio resource measurements for beam tracking. As a result, there exists a technical problem of how to attain accurate beam management in new radio interface with reduced complexity, and reduced overhead of beam reporting.

Therefore, in light of the foregoing discussion, there exists a need to overcome the aforementioned drawbacks associated with the conventional radio access networks for beam management.

### SUMMARY

The present disclosure provides a signal transmitting apparatus and a corresponding method for generating a channel state information (CSI) report. Furthermore, the present disclosure further provides a network node and a corresponding method for managing CSI measurements and reporting. The present disclosure provides a solution to the existing problem with the conventional radio access networks for beam management. An objective of the present disclosure is to provide a solution that overcomes at least partially the problems encountered in the prior art and provides an improved signal transmitting apparatus and an improved method for generating a channel state information (CSI) report. The present disclosure further provides an improved network node and an improved method for managing CSI measurements for dynamic beam reporting format.

One or more objectives of the present disclosure are achieved by the solutions provided in the enclosed independent claims. Advantageous implementations of the present disclosure are further defined in the dependent claims.

In one aspect, the present disclosure provides a signal transmitting apparatus configured for generating a statistical channel state information (CSI) report for beam reporting. The signal transmitting apparatus is further configured to select a subset of configured reference signal (RS) resources and perform measurements of qualities on the subset of RS resources. Further, the signal transmitting apparatus determines a signal quality for each measured RS resource and determines statistics for the determined signal qualities. The signal transmitting apparatus is configured to predict a future signal quality based on the statistics for the determined signal qualities and generate the statistical CSI report based on the statistics for the determined signal qualities. Further, the signal transmitting apparatus is configured to transmit the statistical CSI report to a network node and receive an indication of one or more beams in response thereto. The indicated beams are selected based, at least, on the statistical CSI report.

The signal transmitting apparatus is configured to generate the statistical CSI report with a dynamic beam reporting format to provide guidance for beam prediction. The signal transmitting apparatus performs beam management in new radio (NR), especially in higher frequency ranges. The signal transmitting apparatus is configured to determine the statistics of the signal quality that is used to provide guidance for beam prediction by the network node with reduced prediction error. In addition, the signal transmitting apparatus is used to reduce the overhead of the beam reporting format, with minimal information loss, leveraging prediction capabilities at the network node to support a higher number of reported beams, efficiently. Thus, the signal transmitting apparatus monitors a beam model performance consequently to detect a drift of the beam predictions from measurements data, and consequently the need to update the bam prediction model.

In a further implementation form, the signal transmitting apparatus is further configured to determine the statistics based on a time-series of measured qualities, wherein the statistics are determined over one or more measurement instances. The number of measurements included in the time series of measured qualities may be configured by the network or autonomously selected by the signal transmitting apparatus and indicated to the network node.

The one or more fields (L) include statistics for the determined signal qualities that are used to provide the beam prediction instance for which the prediction range indication is requested for beam reporting.

In a further implementation form, the indicator is used for more than one measured RS resource.

The indicator is used to point to the measured RS resources that are further used to determine the signal qualities.

In a further implementation form, the signal quality is determined based on reference signal received power (RSRP).

In a further implementation form, the signal quality is determined based on signal to interference and noise ratio (SINR).

By virtue of determining the signal qualities based on the RSRP and the SINR, the signal transmitting apparatus can determine the signal strength.

In a further implementation form, the statistics for the determined signal qualities comprise a mean value and a standard deviation for the signal quality.

The mean value and the standard deviation of the signal quality provide the statistics for the determined signal quality and can be used to determine a range for predicted signal quality values.

In a further implementation form, the statistics for the determined signal qualities comprise a minimum value.

In this implementation, the minimum value of the signal quality is used to determine a lower bound for predicted signal quality values.

In a further implementation form, the statistics for the determined signal qualities comprise a quantile value.

In this implementation, the quantile value is used to determine the statistics of the predicted signal quality values.

In a further implementation form, the signal quality values indicate a range of predicted signal quality values, for one or multiple time periods.

The range of predicted signal quality values (i.e., prediction on the statistics for the determined signal qualities) is used to avoid or at least reduce the overhead of beam reporting, while providing information to optimize beam predictions at the network for multiple prediction time instances.

In a further implementation form, the signal transmitting apparatus is further configured to select the subset of configured reference signal (RS) resources based on RSRP variance or SINR variance, autocorrelation over time of RSRP or SINR, Measured Doppler shift or phase noise.

In this implementation, the subset of the configured RS resources is used to determine the signal quality that is further used to reduce error prediction and improve beam prediction robustness.

In a further implementation form, the signal transmitting apparatus is further configured to receive an indication of a report format switch from a network node and determine the new report format according to the received switching command and RRC configuration, and, in response thereto, generate the statistical CSI report according to the determined new format.

The indication of the report format switch is used to provide an indication of switching from a conventional beam report to an inference/monitoring beam report.

In a further implementation form, the signal transmitting apparatus is further configured to determine a reporting format switch time and transmit to the network node a beam reporting format switching request, at the determined time.

In this implementation, the signal transmitting apparatus selects the reporting format switch time (i.e., desired time to switch) for the format of beam reporting based on the report switch time. Thereafter, the signal transmitting apparatus switches the beam reporting format autonomously or following network indication, depending on the defined criteria of the signal transmitting apparatus or network configured criteria of the network.

In another aspect, the present disclosure provides a network node that is configured for managing CSI measurements and reporting. The network node is configured to configure the signal transmitting apparatus with statistical CSI reporting configurations. Further, the network node is configured to receive statistical CSI reports from a signal transmitting apparatus and transmit an indication of a report format switch to the signal transmitting apparatus. Further, the network node receives a statistical CSI report and determines updated beams based on the statistical CSI report. Further, the network node transmits beam indications to the signal transmitting apparatus. Beam indications may be transmitted as transmission state indicators for downlink and/or Uplink channels. Alternately, beams may be indicated using reference signal resource indicators.

The network node with dynamic beam reporting format is used for beam management and reporting for a new radio, especially in higher frequency ranges where beamforming is critical to guarantee coverage, such as through dynamically switching between inference (or monitoring) format and other formats with reduced beam sweeping overhead and latency. The network node is used to reduce the overhead of beam reporting, with minimal information loss, leveraging prediction capabilities at the network. The network node is used to monitor the performance of the beam prediction model and identify opportune timings for updates or/and switching of the beam prediction model to avoid high prediction errors, consequently improving robustness.

In yet another aspect, the present disclosure provides a method for use in a signal transmitting apparatus configured for generating a statistical channel state information, CSI, report for beam reporting. The method includes selecting a subset of a configured reference signal, RS, resources, and performing measurements of qualities on the subset of RS resources. Further, the method includes determining signal quality for each measured RS resource and determining statistics for the determined signal qualities. The method further includes predicting a future signal quality based on the statistics for the determined signal qualities and generating the statistical CSI report based on the statistics for the determined signal qualities. Further, the method includes transmitting the statistical CSI report to the network node and receiving an indication of one or more beam indications in response thereto and the indicated beams are selected based, at least, on the statistical CSI report.

The method achieves all the advantages and technical effects of the signal transmitting apparatus of the present disclosure.

In another aspect, the present disclosure provides a method for use in a network node that is configured for managing CSI measurements and reporting. The method includes configuring the signal transmitting apparatus with statistical CSI reporting configurations and receiving CSI reports from a signal transmitting apparatus. Further, the method includes transmitting an indication of a report format switch to the signal transmitting apparatus and receiving a statistical CSI report. Further, the method includes determining updated beams based on the statistical CSI report and transmitting the beam indications to the signal transmitting apparatus.

The method achieves all the advantages and technical effects of the network node of the present disclosure.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a network diagram of a wireless communication system, in accordance with an embodiment of the present disclosure;

FIG. 1B, is a block diagram that depicts a signal transmitting apparatus, in accordance with an embodiment of the present disclosure;

FIG. 1C is a block diagram that depicts a network node for managing channel state information (CSI) measurements and reporting, in accordance with an embodiment of the present disclosure;

FIG. 2 is a diagram that depicts switching between full channel state information report to inference input report, in accordance with an embodiment of the present disclosure;

FIG. 3A is a sequence diagram that depicts signalling flow for network node-initiated inference or monitoring format reporting, in accordance with an embodiment of the present disclosure;

FIG. 3B is a sequence diagram that depicts signalling flow for client device-initiated inference/monitoring format reporting, in accordance with an embodiment of the present disclosure;

FIG. 3C is a sequence diagram that depicts signalling flow for client device-recommended inference/monitoring format reporting, in accordance with an embodiment of the present disclosure;

FIG. 4 is a flow chart of a method for use in a signal transmitting apparatus configured for generating a Channel State Information (CSI), report for beam reporting, in accordance with another embodiment of the present disclosure; and

FIG. 5 is a flow chart of a method for use in a network node configured for managing CSI measurements and reporting, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

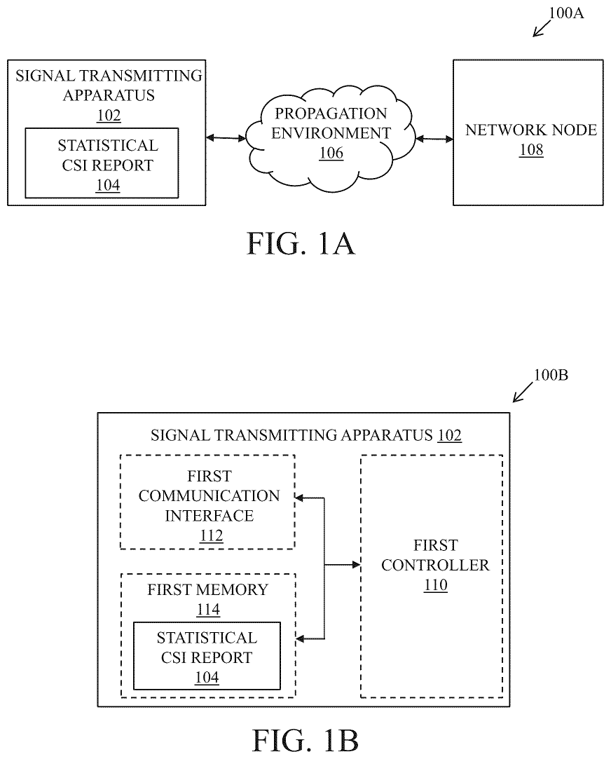

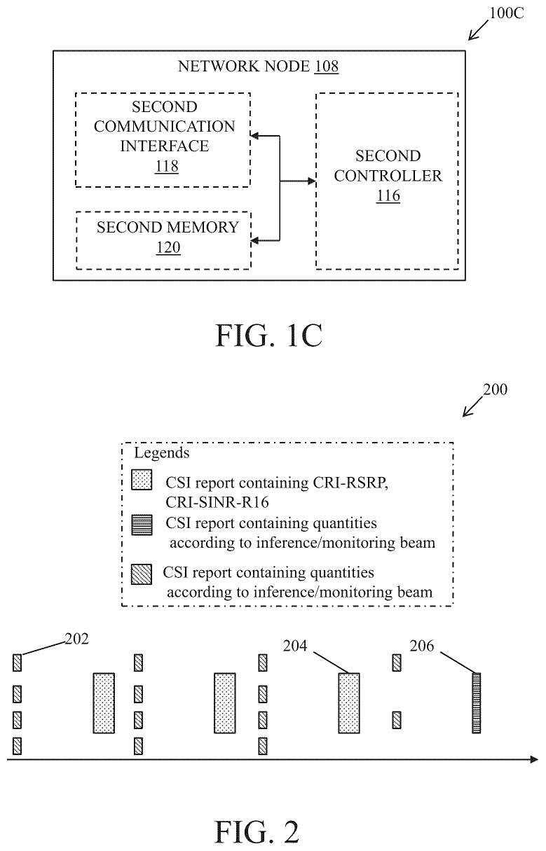

FIG. 1A is a network diagram of a wireless communication system, in accordance with an embodiment of the present disclosure. With reference to FIG. 1A, there is shown the network diagram of a wireless communication system 100A that includes a signal transmitting apparatus 102, a propagation environment 106, and a network node 108. Furthermore, the signal transmitting apparatus 102 includes a statistical channel state information (CSI) report 104.

The wireless communication system 100A includes the signal transmitting apparatus 102, the propagation environment 106, and the network node 108. The signal transmitting apparatus 102 is configured to generate the statistical CSI report 104 for beam reporting that is used in beam management. Examples of the signal transmitting apparatus 102 may include but are not limited to, a transmitter, a sender, a transceiver, an encoder, a user terminal of a cellular network, a customized hardware for wireless telecommunication, or any other portable or non-portable electronic device, client device, user equipment, and the like. Furthermore, the network node 108 is configured to manage CSI measurements and reporting. Examples of the network node 108 may include but are not limited to, a receiver, a decoder, a transceiver, a base station or an access point in a cellular network, and the like.

The propagation environment 106 includes a medium (e.g., a communication channel) through which one or more transmitting devices, such as the signal transmitting apparatus 102, potentially communicate with the network node 108. The network node may belong to a wider network. Examples of the networks may include, but are not limited to, a cellular network, a wireless sensor network (WSN), a cloud network, a Local Area Network (LAN), a vehicle-to-network (V2N) network, a Metropolitan Area Network (MAN), and the like.

In operation, the signal transmitting apparatus 102 is configured to generate the statistical CSI report 104 for beam reporting that is used in beam management, such as through-beam prediction. The statistical CSI report 104 includes one or more fields (N) that include an indicator for each measured reference signal (RS) resource or resource subset, one or more fields (M) that includes measured signal qualities, one or more fields (L) that include statistics for the determined signal qualities, for one or more prediction time instances. The signal transmitting apparatus 102 is configured to select a subset of configured RS resources and perform measurements of signal qualities on the subset of RS resources. Furthermore, the signal transmitting apparatus 102 is configured to determine signal qualities for each measured RS resource and statistics from the determined signal qualities. Furthermore, the signal transmitting apparatus 102 is configured to predict a future signal quality or quality statistic based on the statistics for the determined signal qualities and generate the statistical CSI report 104. Thereafter, the signal transmitting apparatus 102 is configured to transmit the statistical CSI report 104 to the network node 108 and receive an indication of one or more beams. Moreover, the indicated beams are selected based at least on the statistical CSI report 104.

The network node 108 is configured to manage CSI measurements and reporting. The network node 108 is used to configure the signal transmitting apparatus 102 with CSI reporting configurations, including a statistical CSI reporting configuration. Furthermore, the network node 108 is configured to receive statistical CSI reports from the signal transmitting apparatus 102 and transmit an indication of a report format switch to the signal transmitting apparatus 102. Furthermore, the network node 108 is configured to receive the statistical CSI report 104 and determine updated beams based on the statistical CSI report 104. Finally, the network node 108 is configured to transmit beam indications to the signal transmitting apparatus 102.

FIG. 1B, is a block diagram that depicts a signal transmitting apparatus, in accordance with different embodiments of the present disclosure. With reference to FIG. 1B there is shown a block diagram 100B of the signal transmitting apparatus 102 that includes a first communication interface 112, a first memory 114, and a first controller 110.

The first communication interface 112 is used by the signal transmitting apparatus 102 to communicate with the network node 108. Examples of implementation of the first communication interface 112 may include but are not limited to a network interface, a computer port, a network socket, a network interface controller (NIC), and any other network interface device.

The first controller 110 is configured to generate the statistical channel state information (CSI) report 104. Examples of implementation of the first controller 110 may include but are not limited to a central data processing device, a microprocessor, a microcontroller, a complex instruction set computing (CISC) processor, an application-specific integrated circuit (ASIC) processor, a reduced instruction set (RISC) processor, a very long instruction word (VLIW) processor, a state machine, and other processors or control circuitry.

The first memory 114 is configured to store the statistical CSI report 104. Examples of implementation of the first memory 114 may include, but are not limited to, Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The signal transmitting apparatus 102 is configured to generate the statistical CSI report 104 for beam reporting. The beam reporting is used for beam management, in new radio (NR), especially in higher frequency ranges. In an implementation, the statistical CSI report 104 provides a framework for beam reporting to provide beam prediction guidance at the Network Node 108.

In accordance with an embodiment, the statistical CSI report 104 includes one or more fields (N) that include an indicator for each measured reference signal (RS) resource. Moreover, the indicator is a CSI-RS resource indicator (CRI) or a SS/PBCH resource block indicator (SSBRI). Firstly, the signal transmitting apparatus 102 is configured to point to each measured RS resource that is identified using the CRI. Thereafter, the signal transmitting apparatus 102 is configured to generate the statistical CSI report 104. In an implementation, the indicator is referred to as the CRI. In another implementation, the indicator is referred to as the SSBRI. In accordance with an embodiment, the indicator is used for more than one measured reference signal (RS) resource. The indicator is used to point to the measured RS resources that are further used to determine the signal qualities. In addition, the statistical CSI report 104 includes one or more fields (M) that include measured signal qualities, one or more fields (L) that include statistics for the determined signal qualities, one field for each prediction time instance. In an implementation, the one or more fields (M) that are included in the statistical CSI report 104 provide reference signal received power (RSRP) values. In another implementation, the one or more fields (L) corresponds to number of beam prediction instances for which the prediction range indication is requested for beam reporting. Moreover, the overhead of the inference beam report for the input to a beam prediction model can be dynamically adapted by selecting a specific combination of parameters from a set of pre-configured combinations, such as from the one or more fields (N), the one or more fields (M), or the one or more fields (L). In an implementation, the overhead of the inference beam report for input to the beam prediction model can be dynamically adapted. In another implementation, the mapping of CSI fields for beam reporting for a given set of parameters (N, M, L) is shown below in table 1.

TABLE 1

| CSI report | CSI fields |
|---|---|
| CSI report #n | CRI or SSBRI #1 |
| | . . . |
| | CRI or SSBRI #N |
| | L1-RSRP or L1-SINR #1 |
| | . . . |
| | L1-RSRP or L1-SINR #M |
| | Standard deviation and/or mean of differential L1- |
| | RSRP or L1-SINR prediction step #1 |
| | . . . |
| | Standard deviation and/or mean of differential L1- |
| | RSRP or L1-SINR prediction step # L |

The signal transmitting apparatus 102 is configured to select a subset of configured RS resources. In an implementation, the signal transmitting apparatus 102 is configured to select the subset from the configured CMR/IMR to compute beam inference input. Moreover, the signal transmitting apparatus 102 may select the RS resources based on a locally learned criterion, such as through resources with the highest RSRP and signal-to-interference-plus-noise ratio (SINR) variance. In accordance with an embodiment, the RS resources are channel measurement resources. The channel measurement resources correspond to the measurement resources that provide an information about the channel (e.g., the propagation environment 106) in which the signal is transmitted. In accordance with another embodiment, the RS resources are interference measurement resources. In an implementation, the signal transmitting apparatus 102 is configured to select the subset of the interference measurement resources that are required to determine the signal quality for beam management. In accordance with an embodiment, the signal transmitting apparatus 102 is configured to select the subset of configured RS resources based on the RSRP variance or the SINR variance or autocorrelation over time of the RSRP or the SINR. In an implementation, the signal transmitting apparatus 102 is configured to select the subset of the configured RS resources based on the RSRP variance. In another implementation, the signal transmitting apparatus 102 is configured to select the subset of the configured RS resources based on the SINR variance. In yet another implementation, the signal transmitting apparatus 102 is configured to select the subset of the configured RS resources based on the autocorrelation over time of RSRP. In another implementation, the signal transmitting apparatus 102 is configured to select the subset of the configured RS resources based on the autocorrelation over time of the SINR. Thus, the signal transmitting apparatus 102 is configured to select the subset of the configured RS resources that are used to determine the signal quality that is further used to reduce error prediction and robustness.

Furthermore, the signal transmitting apparatus 102 is configured to perform measurements of qualities on the subset of the RS resource. In an implementation, the signal transmitting apparatus 102 is configured to perform measurements of qualities on the subset of the RS resource to provide the CRI/SSBRI. In an implementation, the signal transmitting apparatus 102 is configured to perform measurements of qualities on the subset of the RS resource to predict RSRP/SINR values, such as out of the active bandwidth part over at least one of a number of instances, the DL RS resources, ports, reports that indicate ranges for network node side prediction, and the like. Thus, the measurements of qualities on the subset of the RS resource are used to feed and report RSRP (or SINR) over a number of prediction instances for beam reporting.

Further, the signal transmitting apparatus 102 is configured to determine signal qualities for each measured RS resource. The signal qualities correspond to the data transmission capabilities of each measured RS resource. Moreover, the signal qualities for each measured RS resource are determined on the basis of the measurements of qualities on the subset of the RS resource, such as through a time series of measured qualities. In accordance with an embodiment, the signal transmitting apparatus 102 is configured to determine signal qualities over time by performing measurements on the subset of RS resources, determining the signal quality for each measured RS resource at a plurality of times, and generating a time series of measured qualities. Moreover, the statistics are determined based on the time series of measured qualities. The signal transmitting apparatus 102 is configured to perform measurements and thereafter determine the signal qualities to generate the statistical CSI report 104 for beam reporting a plurality of times (or time period) to capture the signal qualities in every interval of time. In accordance with an embodiment, the signal qualities are determined as RSRP. In an implementation, the RSRP is used to provide the signal quality, such as based on an RSRP threshold value. For example, if the RSRP value is higher than the RSRP threshold value, then the signal quality is improved as compared to the scenario in which the RSRP value is below the RSRP threshold value. Thus, the determination of the signal qualities based on the RSRP is used by the signal transmitting apparatus 102 to determine the signal strength. In accordance with an embodiment, the signal qualities are determined as SINR. In an implementation, the SINR is used to provide the signal quality, such as based on an SINR threshold value. For example, if the SINR is higher than the SINR threshold value, then the signal quality is improved as compared to the scenario in which the SINR is below the SINR threshold value. Thus, the determination of the signal qualities based on the SINR is used by the signal transmitting apparatus 102 to determine the signal strength.

Further, the signal transmitting apparatus 102 is configured to determine statistics for the determined signal qualities. Firstly, the signal transmitting apparatus 102 is configured to select the subset of the configured RS resources. Thereafter, the signal transmitting apparatus 102 is configured to perform measurements of qualities on the subset of the RS resources and then determine the signal quality for each measured RS resource. Finally, the signal transmitting apparatus 102 is configured to determine the statistics for the determined signal qualities to generate the statistical CSI report 104. By virtue of determining the statistics for the determined signal qualities of the measured CSI report, the signal transmitting apparatus 102 provides the information that is required to avoid or at least reduce the margins of error in RSRP/SINR estimation. In accordance with an embodiment, the statistics for the determined signal qualities include a mean value and a standard deviation for the signal quality. The mean value and the standard deviation of the signal quality provide the statistics for the determined signal quality, such as fluctuations in the signal to determine the signal quality and to generate the statistical CSI report 104 for beam reporting. In accordance with an embodiment, the statistics for the determined signal qualities include a minimum value. The minimum value of the signal is used to determine the quality of the signal (e.g., low-quality signal) that is used to predict beam prediction and for beam reporting (e.g., for low-quality signal). In accordance with an embodiment, the statistics for the determined signal qualities include a quantile value. In an example, the quantile values correspond to values that split sorted data or a probability distribution into equal parts. The quantile value is used to determine the statistics of the determined signal quality for beam reporting. In accordance with an embodiment, the signal transmitting apparatus 102 is further configured to determine the statistics based on the time-series of measured qualities, and the statistics are determined over one or more fields (L) of measuring instances. The one or more fields (L) are configured by the network or autonomously selected by the signal transmitting apparatus 102 and indicated to the network node 108. The one or more fields (L) include statistics for the determined signal qualities to provide the beam prediction instance for which the prediction range indication is requested for beam reporting.

The signal transmitting apparatus 102 is further configured to predict a future signal quality based on the statistics for the determined signal qualities. Firstly, the signal transmitting apparatus 102 is configured to determine the signal qualities, and thereafter, the signal transmitting apparatus 102 is configured to determine the statistics of the determined signal qualities. Furthermore, the signal transmitting apparatus 102 is configured to predict the future signal quality based on the statistics for the determined signal qualities. In accordance with an embodiment, the future signal quality indicates a range of predicted signal quality values, for one or multiple time periods. The range of predicted signal quality values (i.e., prediction on the statistics for the determined signal qualities) is used to avoid or at least reduce the overhead of beam reporting, with minimal information loss, leveraging prediction capabilities at the network 106 in multiple intervals of time.

The signal transmitting apparatus 102 is configured to generate the statistical CSI report 104 based on the statistics for the determined signal qualities and transmit the statistical CSI report 104 to a network node 108. The signal transmitting apparatus 102 is configured to determine the signal qualities and thereafter generate the statistical CSI report 104. Furthermore, the generated statistical CSI report 104 is transmitted to the network node 108. The statistical CSI report 104 that is generated by the signal transmitting apparatus 102 provides prediction guidance or a format for inference input provided to the network node 108. Additionally, the statistical CSI report 104 also provides a data drift monitoring input for beam reporting and beam management.

In accordance with an embodiment, the signal transmitting apparatus 102 is configured to receive an indication of a report format switch from the network node 108 and determine the new report format according to the received switching command and RRC configuration, and, in response thereto, generate the statistical CSI report 104. The network node 108 is configured to transmit an indication of the report format switch to the signal transmitting apparatus 102. In other words, the network node 108 indicates a switch in the reporting format, such as based on the statistical CSI reporting configurations that are used for beam reporting to the signal transmitting apparatus 102, such as user equipment. Moreover, the indication of the report format switch is used to provide an indication of switching from a conventional beam report to an inference/monitoring beam report. In an example, the indication of the report format switch is used to trigger in beam reporting format to interference/monitoring input reporting via dynamic downlink signaling. Thereafter, the signal transmitting apparatus 102 is configured to receive the indication of the report format switch and determine the new report format according to the received switching command and RRC configuration, and, in response thereto, generate the statistical CSI report. In accordance with such embodiment, the signal transmitting apparatus 102 is configured to determine a reporting format switch time and transmit to the network node 108 a beam reporting format switching request, at the determined time. In other words, the signal transmitting apparatus 102 selects the reporting format switch time (i.e., desired time to switch) for the format of beam reporting based on the report switch time, and switches the beam reporting format autonomously, such as depending on the defined criteria of the signal transmitting apparatus 102 or network configured criteria of the network 106. Moreover, the signal transmitting apparatus 102 is configured to transmit the beam reporting format switching request to the network node 108, at the determined time.

Furthermore, the signal transmitting apparatus 102 is configured to receive an indication of one or more beams in response thereto and the indicated beams are selected based, at least, on the statistical CSI report 104. Firstly, the network node 108 is used to configure the signal transmitting apparatus 102 with CSI reporting configurations. Thereafter, the network node 108 is configured to receive CSI reports from the signal transmitting apparatus 102. Furthermore, the network node 108 is configured to transmit the indication of the report format switch to the signal transmitting apparatus 102 and receive the statistical CSI report 104 that is transmitted by the signal transmitting apparatus 102. In addition, the network node 108 is configured to determine updated beams based on the statistical CSI report 104 and then transmit beam indications to the signal transmitting apparatus 102 that further select the indicated beams based on the statistical CSI report 104. In accordance with an embodiment, the signal transmitting apparatus 102 is further configured to receive the indication of the one or more fields (N), one or more fields (M), and/or one or more fields (L) from the network node 108. In an implementation, the signal transmitting apparatus 102 is configured to receive the indication for one or more fields (N), one or more fields (M), and the one or more fields (L) from the network node 108. In another implementation, the signal transmitting apparatus 102 is configured to receive the indication for one or more fields (N), the one or more fields (M), or the one or more fields (L) from the network node 108. In accordance with an embodiment, the indicated beams include one or more transmission beams. In an example, each beam from the one or more transmission beams includes respective identity information of the signal transmitting apparatus 102. In accordance with an embodiment, the indicated beams include one or more reception beams. In an example, each beam from the one or more reception beams includes respective identity information of the signal transmitting apparatus 102.

The signal transmitting apparatus 102 is configured to generate the statistical CSI report for beam reporting. The signal transmitting apparatus 102 is configured to determine the statistics of the signal quality that is used to provide the beam prediction guidance by the network node 108 with reduced prediction error. In addition, the signal transmitting apparatus 102 is used to reduce the overhead of beam reporting, with minimal information loss, leveraging prediction capabilities at the network node 108 to support a higher number of reported beams, efficiently. Thus, the signal transmitting apparatus 102 monitors a beam model performance consequently to detect data drift for the beam management of the new radio interface with reduced complexity, and reduced overhead.

FIG. 1C is a block diagram that depicts a network node for managing channel state information (CSI) measurements and reporting, in accordance with different embodiments of the present disclosure. With reference to FIG. 1C, there is shown a block diagram 100C of the network node 108 that includes a second controller 116, a second communication interface 118, and a second memory 120.

The second communication interface 118 is used by the network node 108 to communicate with the signal transmitting apparatus 102. Examples of implementation of the second communication interface 118 may include but are not limited to a network interface, a computer port, a network socket, a network interface controller (NIC), and any other network interface device.

The second controller 116 of the network node 108 is configured to manage the CSI measurements and reporting. Examples of implementation of the second controller 116 may include but are not limited to a central data processing device, a microprocessor, a microcontroller, a complex instruction set computing (CISC) processor, an application-specific integrated circuit (ASIC) processor, a reduced instruction set (RISC) processor, a very long instruction word (VLIW) processor, a state machine, and other processors or control circuitry.

The second memory 120 is configured to store the CSI measurements. Examples of implementation of the second memory 120 may include, but are not limited to, Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

FIG. 2 is a diagram that depicts switching between full channel state information report to inference input report, in accordance with an embodiment of the present disclosure. FIG. 1B is described in conjunction with elements from FIG. 2. With reference to FIG. 2 there is shown a diagram of switching between beam reporting formats, such as through a first indicator 202, a second indicator 204, a third indicator 206, and a fourth indicator 208. The first indicator 202 indicates the CSI measurement reference signal resources. The second indicator 204 indicates the CSI report that contains the CRI or SSBRI and -RSRP or -SINR in a full channel state information report. Furthermore, the third indicator 206 indicates the CSI report that contains quantities according to inference (or monitoring). Thus, the first indicator 202, the second indicator 204, and the third indicator 206 collectively represents the switching between the full CSI report to the inference (or monitoring) input report.

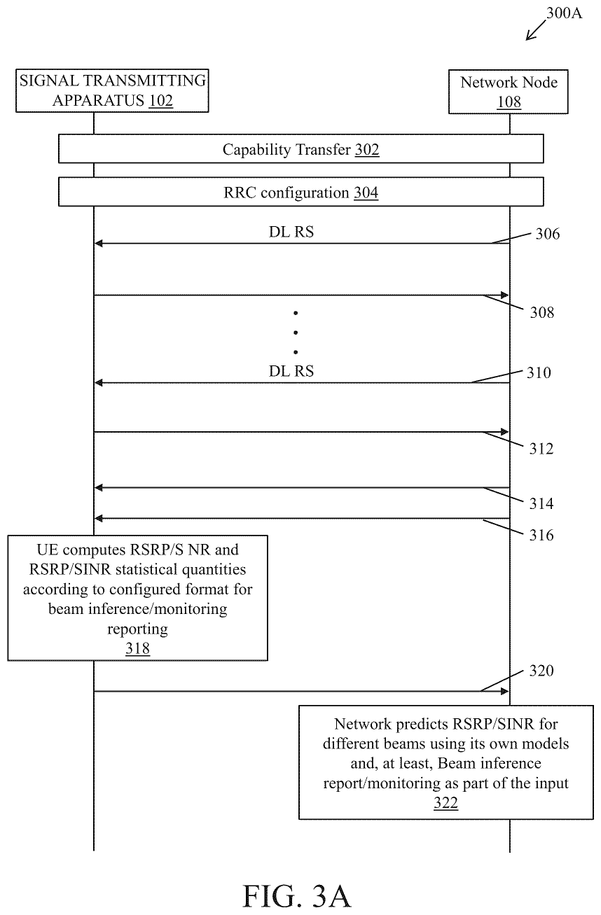

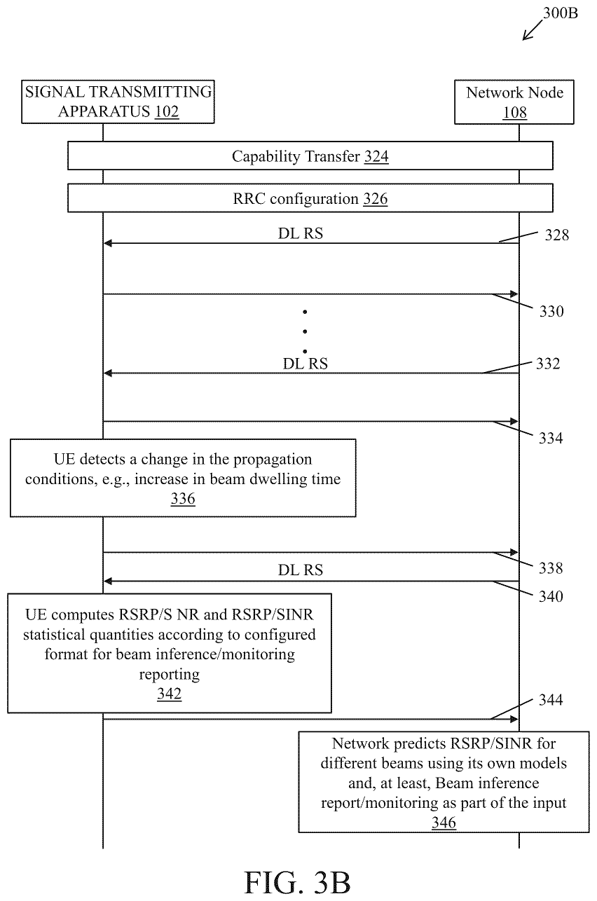

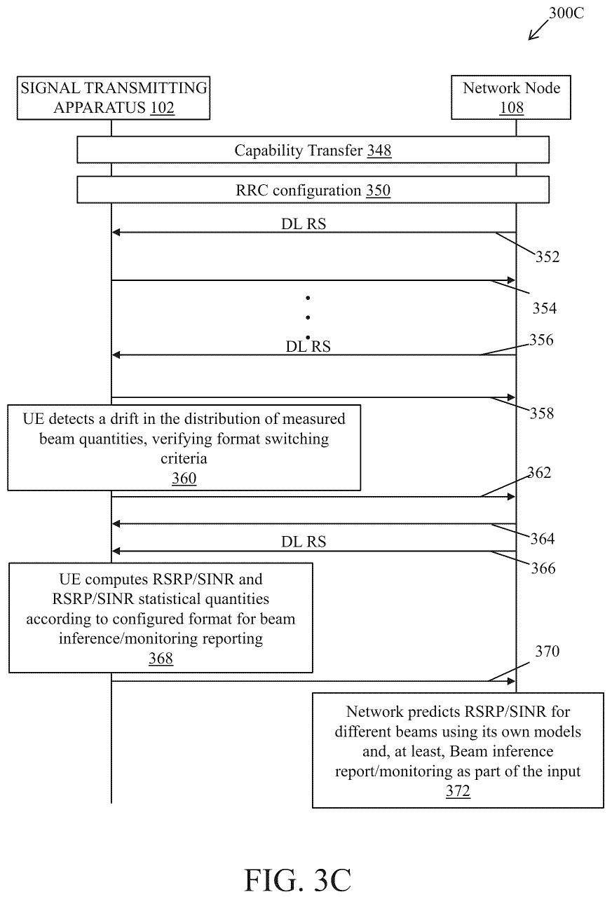

FIG. 3A is a sequence diagram that depicts signalling flow for network node-initiated beam reporting format switching to inference/monitoring format reporting, in accordance with an embodiment of the present disclosure. FIG. 3A is described in conjunction with elements from FIGS. 1A to 2. With reference to FIG. 3A, there is shown a sequence diagram 300A that includes operations from 302 to 322 to manage channel state information (CSI) measurements and reporting for beam management. The sequence diagram 300A further depicts signalling flow for the network node 108 (of FIG. 1A) initiated beam reporting format switching to inference (or monitoring) format reporting.

In operation, the network node 108 is configured to manage CSI measurements and reporting, such as the network node 108 is used to configure the signal transmitting apparatus 102 with statistical CSI reporting configurations. In other words, the network node 108 is used to configure the signal transmitting apparatus 102, such as the user equipment with CSI measurement and reporting configurations, including statistical CSI reporting configurations for beam reporting. In an implementation, the CSI reporting configurations include at least two CSI reporting configurations, that indicate Channel state information-Reference signal resource Indicator (CRI), or Synchronization Signal/Physical Broadcast Channel (SS/PBCH) Resource Block Indicator (SSBRI). In addition, the CSI reporting configurations further include beam level reference signal received power (L1-RSRP) or beam level signal to interference & noise ratio (L1-SINR) as reporting quantities. The two CSI reporting configuration are implicitly or explicitly linked in radio resource control (RRC), such as in higher RRC configuration/reconfiguration, or are linked using L1/L2 dynamic signalling. Further, at operation 302, and operation 304, the network node 108 is used to configure the signal transmitting apparatus 102 with CSI reporting configurations, including statistical CSI reporting configurations. Moreover, at least two of the aforementioned linked CSI configurations indicate different CSI reporting formats for beam reporting, and one format is reserved for inference or monitoring instances. In another implementation, the CSI reporting configurations include at least one CSI reporting configuration, indicating CRI (or SSBRI) and L1-RSRP (or L1-SINR) as reporting quantities, configuring more than a format for beam reporting, and one format is reserved for inference or monitoring instances. In yet another implementation, for the inference/monitoring format, the CSI reporting configuration further includes a set of parameters that define the number of quantities that need to be included in the report.

At operation 306, the network node 108 is further configured to transmit downlink reference signal (DL RS) resources to the signal transmitting apparatus 102. Thereafter, the signal transmitting apparatus 102 is configured to transmit CSI reports to the network node 108. Moreover, at operation 308, the network node 108 is further configured to receive CSI reports from the signal transmitting apparatus 102. The network node 108 is configured to receive one or more CSI reports, containing CSI quantities according to a first reporting format. Thereafter, at operation 310, the network node 108 is configured to transmit downlink reference signal (DL RS) resources to the signal transmitting apparatus 102. Moreover, at operation 312, the network node 108 is further configured to receive other CSI reports from the signal transmitting apparatus 102. As a result, the network node received a plurality of statistical CSI reports from the signal transmitting apparatus 102. In an implementation, the CSI report 104 includes CRI-RSRP, SSB-index-RSRP, CRI-SINR-R16, or SSB-index-SINR-R16.

At operation 314, the network node 108 is configured to transmit an indication of the report format switch to the signal transmitting apparatus 102. In other words, the network node 108 indicates a switch in the reporting format. The indication of the report format switch is used to provide an indication of switching from a conventional beam report to an inference/monitoring beam report. In an example, the indication of the report format switch is used to trigger a change in beam reporting format to interference/monitoring input reporting. Thereafter, the signal transmitting apparatus 102 is configured to receive the indication of the report format switch and determine a new report format according to the received switching command and RRC configuration, and, in response thereto, generate the statistical CSI report. In addition, at operation 316, the network node 108 is further configured to transmit DL RS resources to the signal transmitting apparatus 102. In accordance with an embodiment, the network node 108 is further configured to determine that the signal quality values are predictable, and in response thereto the network node 108 is configured to determine the report format switch. In an example, the signal quality values are used to predict high correlation across resources or time. The signal transmitting apparatus 102 is further configured to perform measurements of qualities on the subset of the DL RS resources, determine signal quality for each measured DL RS resource as well as statistics for the determined signal qualities. Thereafter, the signal transmitting apparatus 102 is configured to determine a reporting format switch time and transmit a beam reporting format switching request to the network node 108, such as a Next Generation Node Base Station (gNB), at the determined time. In accordance with an embodiment, the network node 108 is further configured to receive the beam reporting format switch request from the signal transmitting apparatus 102 and determine the report switch time based on the received beam reporting format switch request. In an implementation, the signal transmitting apparatus 102 may indicate to the network node 108 an opportune timing to switch the beam reporting format and appropriate beam switching time, such as based on the received beam reporting format switch request and also based on estimation of doppler at the signal transmitting apparatus 102. Moreover, the network node 108 is configured to determine the report switch time, and then transmit the indication of the report format switch to the signal transmitting apparatus 102. After that, the signal transmitting apparatus 102 selects the desired time to switch the format of beam reporting based on the report switch time, and switches the beam reporting format autonomously, such as depending on defined criteria of the signal transmitting apparatus 102 or network configured criteria of the network node 108. The beam reporting format is used to avoid high prediction errors and consequently improve robustness.

The network node 108 is further configured to receive the statistical CSI report 104 from the signal transmitting apparatus 102. Therefore, the network node 108 is configured to activate or deactivate the reporting behavior of the signal transmitting apparatus 102, either by activating/deactivating the CSI reporting configurations or by activating or deactivating a specific format of the CSI reporting configurations. In addition, the statistical CSI report 104 is received based on a new format for CRI-RSRP and SSB-index-RSRP reporting. Moreover, the new format for beam reporting may be considered for the DL RS resources in the same BWP or for the DL RS resources from different BWPs/including measurement gaps. In addition, statistical quantities of the statistical CSI report 104 are computed for resources coming from multiple transmission reception points (TRPs). In an example, such statistical quantities may be computed with respect to beam groups, such as in a case where group-based beam reporting is enabled. After that, the network node 108 is configured to determine updated beams based on the statistical CSI report 104. As a result, the updated beams are also based on the new report format. Moreover, by virtue of using appropriate models of the report format switch, the network node 108 is configured to update spatial characteristics of a propagation environment, due to which the network node 108 can infer optimal beams from a reduced set of the DL RS resource measurements. In addition, sweeping delay (or overhead delay) can be reduced or the number of narrow beams can be increased as compared to the conventional approaches.

In accordance with an embodiment, the network node 108 is further configured to determine a beam prediction based on the statistical CSI report 104 and determine configurations for the updated beam based on the beam prediction. In other words, the statistical CSI report 104 includes a new report format that can be used as means to bound the beam prediction at the network node 108, such as within the range indicated by the signal transmitting apparatus 102. The beam prediction (or TCI state prediction) is used by the network node 108 to streamline beam management for the updated beam. In an example, the network node 108 is configured to determine the beam prediction that can be leveraged in order to monitor the performance and the drift of different statistical models used at the network node 108 for beam prediction. Consequently, abnormal beam prediction, as well as abnormal beam prediction (e.g., outliers), can be limited and the network node 108 can achieve an improved prediction accuracy as compared to the conventional approach.

In accordance with an embodiment, the network node 108 is configured to determine the beam prediction in time-domain utilizing machine learning. In an implementation, the report format switches in instances where the beam prediction is determined by the network node 108 in the time-domain, such as time-domain by utilizing the machine learning (e.g., in time or space domains). In an example, the format switching is also used for monitoring the instances, and the network node 108 is configured to verify beam prediction data drift. By virtue of utilizing the machine learning for beam prediction in the time-domain, the network node 108 can perform beam management with improved accuracy for beam selection, while overhead, as well as latency, is reduced.

In accordance with an embodiment, the network node 108 is configured to determine the beam prediction in spatial-domain utilizing machine learning. Therefore, by virtue of using the machine learning, the network node 108 is configured to derive the channel spatial characteristics in the spatial-domain. In addition, the network node 108 can subsequently optimize the beam sweeping so that the updated beams (e.g., top beams) are derived for the signal transmitting apparatus 102 from the DL RS resources with reduced measurements. By virtue of utilizing the machine learning for beam-prediction in the spatial-domain, the network node 108 can perform beam management with reduced overhead, reduced latency, and improved accuracy for beam selection. In an implementation, with the advent of the machine learning-based beam management in an air interface of wireless networks, multiple benefits can be harvested including, but not limited to, reduced latency, RS overhead, and reporting overhead in addition to increased spatial resolution (suing an excess of narrower beams).

In accordance with an embodiment, the network node 108 is configured to monitor performance of the beam prediction model based on the statistical CSI report 104. By virtue of monitoring the performance of the beam prediction model, the network node 108 can consequently detect data drift and identify when the beam prediction model needs updating (e.g., retraining or changing). In such embodiments, the network node 108 is configured to determine a time to update and/or switch the beam prediction model based on the monitored performance and the statistical CSI reports. In an implementation, the network node 108 can determine opportune timings to update the beam prediction model based on the monitored performance and the statistical CSI reports. In another implementation, the network node 108 can determine opportune timings to switch the beam prediction model based on the monitored performance and the statistical CSI reports. In yet another implementation, the network node 108 can determine opportune timings to update as well as switch the beam prediction model based on the monitored performance and the statistical CSI reports. As a result, the network node 108 improves the beam management as well as gain, latency, and accuracy, while reducing complexity as well as computation time.

In such embodiment, the network node 108 is further configured to determine the time to update and/or switch the beam prediction model by determining a drift between reported statistical data and model training data or model inference results. In an implementation, the network node 108 is configured to determine the time to update the beam prediction model by determining the drift between reported statistical data and model training data. In another implementation, the network node 108 is configured to determine the time to switch the beam prediction model by determining the drift between reported statistical data and model training data. In yet another implementation, the network node 108 is configured to determine the time to update the beam prediction model by determining the drift between reported statistical data and model inference results, such as inference results refer to the regime where the machine learning models are used for prediction. In another implementation, the network node 108 is configured to determine the time to switch the beam prediction model by determining the drift between reported statistical data and model inference results.

In an implementation, depending on the regime of operations, the requirements in terms of input may differ widely for the network node. Moreover, if beam prediction is not in use or when the network node 108 is collecting data for training models for beam prediction, comprehensive reporting, according to the conventional format is preferred. In other words, during the training phase, the network node 108 is configured to serve with an improved range, such as by collecting the maximum number of measurements in order to obtain enough data for models for beam prediction training. While the rate at which a model for beam prediction training should be retrained (or updated) depends on many factors, it is critical to keep the time scale at which any correction should be made. Indeed, depending on traffic type, channel (e.g., the network 106), capabilities of the signal transmitting apparatus 102, and the like, a prediction error may have a more or less severe impact on performance. In an example, the network node 108 can identify when a drift occurs between the data on which the model for beam prediction training was trained and the currently observed measurements by the signal transmitting apparatus 102. For example, an error in predicting the appropriate TCI state could lead to prompting a beam failure recovery procedure, which can be quite demanding in terms of delay.

The network node 108 is further configured to transmit beam indications to the signal transmitting apparatus 102. Moreover, the signal transmitting apparatus 102 is configured to receive the beam indications, such as of one or more beams in response thereto the beam indications are selected based, at least, on the statistical CSI report. In an implementation, the signal transmitting apparatus 102 is configured to receive the beam indications of the N, M, and/or L from the network node 108. In an example, the indicated beams include one or more transmission beams. In another example, the beam indications include one or more reception beams. The beam indication is used for the dynamic beam reporting format. In addition, at operation 318, the signal transmitting apparatus 102 is configured to compute RSRP/SNR and RSRP/SINR statistical quantities according to configured format for beam inference/monitoring reporting. Thereafter, at operation 320, the signal transmitting apparatus 102 is configured to transmit the beam interference monitoring report to the network node 108. Moreover, at operation 322, the network node 108 predicts the RSRP/SINR for different beams using appropriate models and, at least, Beam inference report/monitoring as part of the input.

The network node 108 with dynamic beam reporting format is used for beam management and reporting for a new radio, especially in higher frequency ranges where beamforming is critical to guarantee coverage, such as through dynamically switching between inference (or monitoring) format and other formats with reduced beam sweeping overhead and latency. The network node 108 is used to reduce the overhead of beam reporting, with minimal information loss, leveraging prediction capabilities that further support an improved number of reported beams, efficiently. The network node 108 is used to monitor the performance of the beam prediction model and identify opportune timings for updates or/and switching of the beam prediction model to avoid high prediction errors, consequently improving robustness.

FIG. 3B is a sequence diagram that depicts signalling flow for client device-initiated beam reporting format switching to inference/monitoring format, in accordance with another embodiment of the present disclosure. FIG. 3B is described in conjunction with elements from FIGS. 1A to 3A. With reference to FIG. 3B, there is shown a sequence diagram 300B that includes operations from 324 to 346 to manage channel state information (CSI) measurements and reporting. The sequence diagram 300B further depicts signalling flow for client device-initiated beam reporting format switching to inference/monitoring format, such as initiated by the signal transmitting apparatus 102.

At operation 324, and operation 326, the network node 108 is used to inquire about and receive information on the signal transmitting apparatus 102 capabilities and configure the signal transmitting apparatus 102 with CSI measurement and reporting configurations, including statistical CSI reporting configurations. At operation 328, the network node 108 is further configured to transmit downlink reference signal (DL RS) resources to the signal transmitting apparatus 102. At operation 330, the network node 108 is further configured to receive CSI reports from the signal transmitting apparatus 102. In an implementation, the CSI report 104 includes CRI-RSRP, SSB-index-RSRP, CRI-SINR-R16, or SSB-index-SINR-R16. Thereafter, at operation 332, the network node 108 is configured to transmit the DL RS resources to the signal transmitting apparatus 102. Moreover, at operation 334, the network node 108 is further configured to receive other CSI reports from the signal transmitting apparatus 102. As a result, the network node received a plurality of CSI reports from the signal transmitting apparatus 102. After that, at operation 336, the signal transmitting apparatus 102 detects a change in the propagation conditions, such as increased beam dwelling time. Furthermore, at operation 338, the signal transmitting apparatus 102 is configured to transmit an indication for beam reporting format or configuration switching message to the network node 108. Moreover, at operation 340, the network node 108 is configured to transmit the DL RS resources to the signal transmitting apparatus 102. After that at operation 342, the signal transmitting apparatus 102 is configured to compute RSRP/SINR and RSRP/SINR statistical quantities according to configured format for beam inference/monitoring reporting. In an example, the number of measurement instances, included in the statistical RSRP/SINR quantities computation are configured by the network node 108. In another example, the number of measurement instances, included in the statistical RSRP/SINR quantities computation is selected by the signal transmitting apparatus 102 and, in another example, indicated to the network node 108. Thereafter, at operation 344, the signal transmitting apparatus 102 is configured to transmit the beam interference monitoring report to the network node 108. Finally, at operation 346, the network node 108 is configured to predict RSRP/SINR for different beams using appropriate models and, at least, beam inference report/monitoring as part of the input.

FIG. 3C is a sequence diagram that depicts signalling flow for client device-recommended beam reporting format switching to inference/monitoring format, in accordance with another embodiment of the present disclosure. FIG. 3C is described in conjunction with elements from FIGS. 1A to 3B. With reference to FIG. 3C, there is shown a sequence diagram 300C that includes operations from 348 to 372 to manage channel state information (CSI) measurements and reporting for beam management. The sequence diagram 300C further depicts signalling flow for client device-recommended beam reporting format switching to inference/monitoring format, such as initiated by the signal transmitting apparatus 102.

At operation 348, and operation 350, the network node 108 is used to configure the signal transmitting apparatus 102 with CSI reporting configurations, including statistical CSI reporting configurations. At operation 352, the network node 108 is further configured to transmit downlink reference signal (DL RS) resources to the signal transmitting apparatus 102. At operation 354, the network node 108 is further configured to receive CSI reports from the signal transmitting apparatus 102. In an implementation, the CSI report 104 includes CRI-RSRP, SSB-index-RSRP, CRI-SINR-R16, or SSB-index-SINR-R16. Thereafter, at operation 356, the network node 108 is configured to transmit the DL RS resources to the signal transmitting apparatus 102. Moreover, at operation 358, the network node 108 is further configured to receive another CSI report from the signal transmitting apparatus 102. As a result, the network node received a plurality of CSI reports from the signal transmitting apparatus 102.

After that, at operation 360, the signal transmitting apparatus 102 UE detects a drift in the distribution of measured beam quantities, verifying format switching criteria. The format switching criteria may be configured by the network node 108 or autonomously determined by the signal transmitting apparatus 102. Furthermore, at operation 362, the signal transmitting apparatus 102 is configured to transmit a recommendation to the network node 102 to switch CSI reporting format to beam inference/monitoring format. Moreover, at operation 364, the network node 102 is configured to trigger a switch in beam reporting to monitoring format. In addition, at operation 366, the network node 102 is also configured to transmit the DL RS resources parallel to the signal transmitting apparatus 102. Thereafter, at operation 368, the signal transmitting apparatus 102 is configured to compute RSRP/SINR and RSRP/SINR statistical quantities according to configured format for beam inference/monitoring reporting. Thereafter, at operation 370, the signal transmitting apparatus 102 is configured to transmit the beam interference monitoring report to the network node 108. Finally, at operation 372, the network node 108 is configured predict RSRP/SINR for different beams using appropriate models and, at least, Beam inference report/monitoring as part of the input.

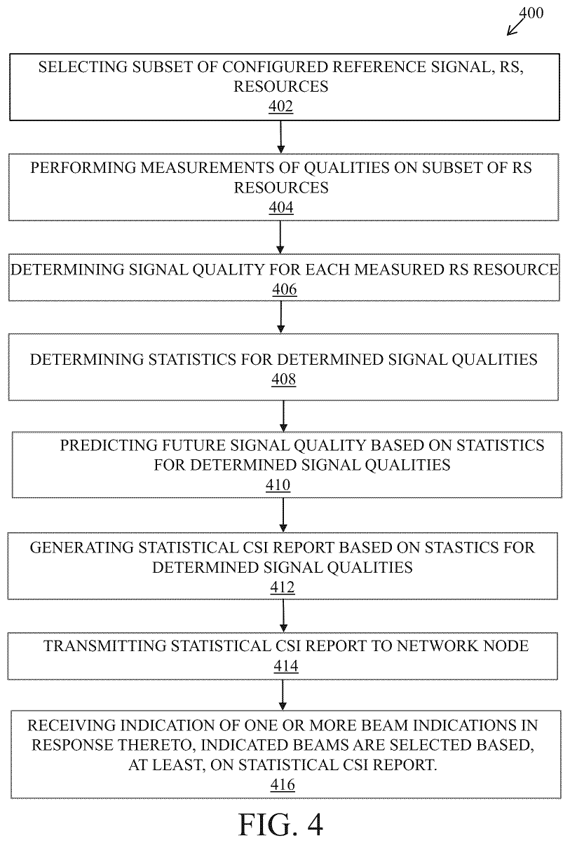

FIG. 4 is a flow chart of a method for use in a signal transmitting apparatus configured for generating a Channel State Information (CSI), report for beam reporting, in accordance with an embodiment of the present disclosure. FIG. 4 is described in conjunction with elements from FIGS. 1A to 3C. With reference to FIG. 4, there is shown a flow chart of a method 400 for use in the signal transmitting apparatus 102 configured for generating the CSI report for beam reporting. The method 400 includes steps 402 to 416.

The method 400 is provided for use in the signal transmitting apparatus 102 that is configured for generating the CSI report for beam reporting. The beam reporting is used for beam management, such as by providing beam prediction capabilities. In an implementation, the statistical CSI report 104 provides a framework for beam reporting to improve beam prediction accuracy at the network node 108.

At step 402, the method 400 comprises selecting a subset of configured reference signal (RS) resources. The signal transmitting apparatus 102 is configured to select the subset of the RS resources.

At step 404, the method 400 comprises performing measurements of qualities on the subset of the RS resources. The signal transmitting apparatus 102 is configured to perform measurements of the qualities on the subset of the RS resources.

At step 406, the method 400 comprises determining signal quality for each measured RS resource. The signal transmitting apparatus 102 is configured to determine the signal quality for each measured RS resource.

At step 408, the method 400 comprises determining statistics for the determined signal qualities. The signal transmitting apparatus 102 is configured to determine statistics for the determined signal qualities. By virtue of determining the statistics for the determined signal qualities of the measured CSI report, the signal transmitting apparatus 102 provides the information that is required to avoid or at least reduce the margins of error in RSRP/SINR prediction.

At step 410, the method 400 comprises predicting a future signal quality based on the statistics for the determined signal qualities. The signal transmitting apparatus 102 is configured to predict the future signal quality based on the statistics for the determined signal qualities. In accordance with an embodiment, the future signal quality indicates a range of predicted signal quality values, for one or multiple time periods. The range of predicted signal quality values (i.e., prediction on the statistics for the determined signal qualities) is used to avoid or at least reduce the overhead of beam reporting, with minimal information loss, leveraging prediction capabilities at the network node 108 over multiple intervals of time.

At step 412, the method 400 comprises generating the statistical CSI report based on the statistics for the determined signal qualities and, in some implementations, on the predicted signal quality values. The signal transmitting apparatus 102 is configured to generate the statistical CSI report based on the statistics for the determined signal qualities and the predicted signal quality values.

At step 414, the method 400 comprises transmitting the statistical CSI report to the network node 108. The signal transmitting apparatus 102 is configured to transmit the statistical CSI report to the network node 108. The statistical CSI report 104 that is generated by the signal transmitting apparatus 102 provides prediction guidance or a format for inference input provided to the network node 108. Additionally, the statistical CSI report 104 also provides a data or performance drift monitoring input for beam management.

At step 416, the method 400 comprises receiving an indication of one or more beam indications in response thereto, and the indicated beams are selected based, at least, on the statistical CSI report. The signal transmitting apparatus 102 is configured to receive the indication of one or more beam indications. In accordance with an embodiment, the indicated beams include one or more transmission beams. In an example, the indicated beams include one or more reception beams. The method 400 is based on an adaptation of the reported CSI quantities by the signal transmitting apparatus 102 (e.g., a client device), in a beam report, for beam (or TCI) state inference instances. Additionally, the method 400 can be leveraged in order to monitor the performance and the drift of the models used at the side of the network node 108 for beam prediction.

The method 400 is used in the signal transmitting apparatus 102 that is configured to generate the statistical CSI report for beam reporting. The method 400 includes determining the statistics of the signal quality that is used for providing guidance information for beam prediction by the network node 108 with reduced prediction error. In addition, the method 400 is used for reducing the overhead of beam reporting, with minimal information loss, leveraging prediction capabilities at the network node 108 to support a higher number of narrow beams, efficiently. Thus, the method 400 is used for monitoring a beam model performance consequently to detect data or performance of beam prediction models.

The steps 402 to 416 are only illustrative, and other alternatives can also be provided where one or more steps are added, one or more steps are removed, or one or more steps are provided in a different sequence without departing from the scope of the claims herein.

There is further provided, a computer program product comprising program instructions for performing the method 400 when executed by one or more processors in a signal transmitting apparatus 102. The computer program product is implemented as an algorithm, embedded in a software stored in a non-transitory computer-readable storage medium. The non-transitory computer-readable storage means may include but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

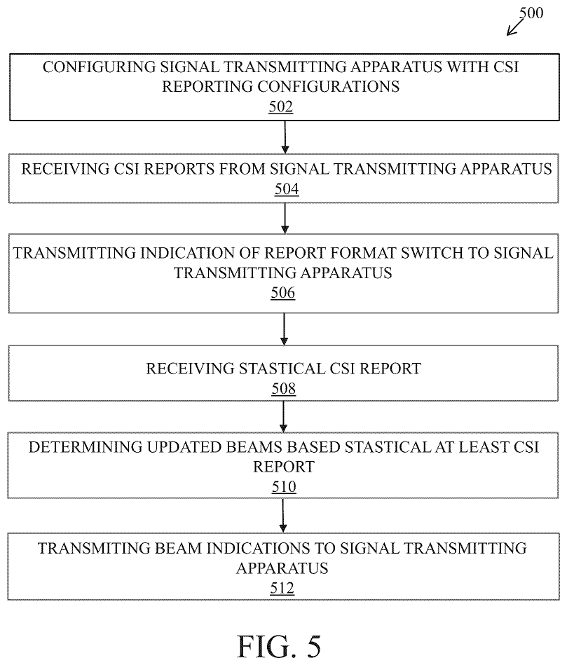

FIG. 5 is a flow chart of a method for use in a network node configured for managing CSI measurements and reporting, in accordance with another embodiment of the present disclosure. FIG. 5 is described in conjunction with elements from FIGS. 1A to 3. With reference to FIG. 5, there is shown a flow chart of a method 500 for use in the network node 108 that is configured for managing CSI measurements and reporting. The method 500 includes steps 502 to 512.

The method 500 is provided for use in the network node 105 that is configured for managing CSI measurements and reporting. At step 502, the method 500 comprises configuring the signal transmitting apparatus 102 with CSI reporting configurations. In other words, the network node 108 is used to configure the signal transmitting apparatus 102, such as the user equipment with CSI reporting configurations, including statistical CSI reporting configurations for beam reporting.

At step 504, the method 500 comprises receiving CSI reports from a signal transmitting apparatus. The network node 108 is configured to receive one or more CSI reports. In an implementation, CSI reports include one or more CSI-RS Resource Indicator (CRI), or a SS/PBCH Resource Block Indicator (SSBRI).

At step 506, the method 500 comprises transmitting an indication of a report format switch to the signal transmitting apparatus. In other words, the network node 108 indicates a switch in the reporting format, such as from conventional beam reporting to inference monitoring format. The indication of the report format switch is used to provide an indication of switching from a conventional beam report to an inference/monitoring beam report.

At step 508, the method 500 comprises receiving a statistical CSI report. The network node 108 is configured to receive the statistical CSI report to activate or deactivate the reporting behavior of the signal transmitting apparatus 102, either by activating/deactivating the CSI reporting configurations or by activating or deactivating a specific format of the CSI reporting configurations.

At step 510, the method 500 comprises determining updated beams based on the statistical CSI report. The network node 108 is configured to determine the updated beams based on the statistical CSI report. As a result, the updated beams are also based on the new report format. Moreover, by virtue of using appropriate models of the report format switch, the network node 108 is configured to update spatial characteristics of a propagation environment, due to which the network node 108 can infer optimal beams from a reduced set of the DL RS resource measurements.

At step 512, the method 500 comprises transmit beam indications to the signal transmitting apparatus 102. The network node 108 is configured to transmit beam indications to the signal transmitting apparatus 102. Moreover, the signal transmitting apparatus 102 is configured to receive the beam indications, such as of one or more beams in response thereto the beam indications are selected based, at least, on the statistical CSI report. In an example, the indicated beams include one or more transmission beams. In another example, the beam indications include one or more reception beams. In addition, the signal transmitting apparatus 102 is configured to compute RSRP/SINR statistical quantities according to configured format for beam inference/monitoring reporting. Thereafter, the signal transmitting apparatus 102 is configured to transmit the beam interference monitoring report to the network node 108.

The method 500 is used for beam management and reporting for new radio with dynamic beam reporting format, especially in higher frequency ranges where beamforming is critical to guarantee coverage, such as through dynamically switching between inference (or monitoring) format and other formats with reduced beam sweeping overhead and latency. The method 500 is used for reducing the overhead of beam reporting, with minimal information loss, leveraging prediction capabilities at the network node. The method 500 is used for monitoring the performance of the beam prediction model and for identifying opportune timings for updates or/and switching of the beam prediction model to avoid high prediction errors, consequently improving robustness.

The steps 502 to 512 are only illustrative, and other alternatives can also be provided where one or more steps are added, one or more steps are removed, or one or more steps are provided in a different sequence without departing from the scope of the claims herein.

There is further provided a computer program product comprising program instructions for performing the method 500 when executed by one or more processors in the network node 108. The computer program product is implemented as an algorithm, embedded in a software stored in a non-transitory computer-readable storage medium. The non-transitory computer-readable storage means may include but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

What is claimed is:

1. A method for use in a signal transmitting apparatus configured for generating a statistical Channel State Information, CSI, report for beam reporting, the method comprising:
selecting a subset of configured reference signal, RS, resources;
performing measurements of qualities on the subset of RS resources;
determining signal quality for each measured RS resource;
determining statistics for the determined signal qualities;
predicting a future signal quality based on the statistics for the determined signal qualities;
generating the statistical CSI report based on the statistics for the determined signal qualities;
transmitting the statistical CSI report to the network node; and
receiving an indication of one or more beam indications in response thereto, wherein the indicated beams are selected based, at least, on the statistical CSI report.

2. The method according to claim 1, wherein the RS resources are channel measurement resources.

3. The method according to claim 1, wherein the RS resources are interference measurement resources.

4. The method according to claim 1, wherein the indicated beams include one or more transmission beams.

5. The method according to claim 1, wherein the indicated beams include one or more reception beams.

6. The method according to claim 1, wherein:
signal quality is determined over time by performing measurements on the subset of RS resources and the signal quality is determined for each measured RS resource at a plurality of times, thereby a time series of measured qualities is generated, wherein the statistics are determined based on the time-series of measured qualities.

7. A method for use in a network node configured for managing CSI measurements and reporting, the method comprising:
configure the signal transmitting apparatus with statistical CSI reporting configurations;
receive statistical CSI reports from a signal transmitting apparatus;
transmit an indication of a report format switch to the signal transmitting apparatus;
receive a statistical CSI report;
determine updated beams based on the statistical CSI report; and
transmit beam indications to the signal transmitting apparatus.

8. The method according to claim 7, wherein the method further comprising: determine a beam prediction based on the statistical CSI report and determine configurations for the updated beam based on the beam prediction.

9. The method according to claim 8, wherein the beam prediction is determined in time-domain utilizing machine learning.

10. The method according to claim 8, wherein the beam prediction is determined in spatial-domain utilizing machine learning.

11. The method according to claim 7, wherein the method further comprising: monitor performance of beam prediction model based on the statistical CSI report.

12. The method according to claim 11, wherein the method further comprising: determine a time to update and/or switch the beam prediction model based on the monitored performance and the statistical CSI reports.

13. An apparatus, wherein the apparatus comprises at least one processor, and one or more memories coupled to the at least one processor and storing programming instructions for execution by the at least one processor to perform operations comprising:
selecting a subset of configured reference signal (RS) resources;
performing measurements of qualities on the subset of RS resources;
determining signal quality for each measured RS resource;
determining statistics for the determined signal qualities;
predicting a future signal quality based on the statistics for the determined signal qualities;
generating statistical Channel State Information (CSI) report (104) based on the statistics for the determined signal qualities;
transmitting the statistical CSI report (104) to the network node (108); and
receiving an indication of one or more beam indications in response thereto, wherein the indicated beams are selected based, at least, on the statistical CSI report (104).

14. The apparatus according to claim 13, wherein the RS resources are channel measurement resources.

15. The apparatus according to claim 13, wherein the RS resources are interference measurement resources.

16. The apparatus according to claim 13, wherein the indicated beams include one or more transmission beams.

17. The apparatus according to claim 13, wherein the indicated beams include one or more reception beams.

18. The apparatus according to claim 13, wherein:
signal quality is determined over time by performing measurements on the subset of RS resources and the signal quality is determined for each measured RS resource at a plurality of times, thereby a time series of measured qualities is generated, wherein the statistics are determined based on the time-series of measured qualities.
